(19) United States
(12) Patent Application Publication
(10) Pub. No.: US 2013/0096781 A1
(43) Pub. Date: Apr. 18, 2013

(54) VEHICULAR WHEEL COVER

(71) Applicants: Thomas George Reichenbach, Carlsbad, CA (US); Paul Beringer Wilbur, West Bloomfield, MI (US); Marques McCammon, San Marcos, CA (US)

(72) Inventors: Thomas George Reichenbach, Carlsbad, CA (US); Paul Beringer Wilbur, West Bloomfield, MI (US); Marques McCammon, San Marcos, CA (US)

(73) Assignee: Aptera Motors, Inc., Carlsbad, CA (US)

(21) Appl. No.: 13/273,548

(22) Filed: Oct. 14, 2011

(51) Int. Cl. B62D 25/18; G06F 7/00; B60Q 1/00; G05G 1/04

(52) U.S. Cl. 701/49; 280/849; 74/469; 362/487

(57) ABSTRACT

An automotive vehicle wheel apparatus includes a turnable cover or door for a wheelhouse opening in a fender. In another aspect, a sheath or liner is provided close to at least half of a circumference of a wheel. A further aspect blocks and/or removes circumferential air moving with a wheel.

### BACKGROUND AND SUMMARY

The present invention relates generally to automotive vehicle aerodynamics and more particularly to an apparatus associated with an automotive vehicle wheel.

There are many aerodynamic inefficiencies associated with rotating wheels of a traditional automotive vehicle. For example, a ball of high pressure turbulent air is created at the front of each wheel where it meets the road thereby creating drag on the vehicle. Furthermore, the wheelhouse, wheel rim and wheelhouse opening in the fender also cause turbulent air flow. For example, turbulent air flow vortices are caused by separation of an air boundary layer developed at outer edges of a conventional wheelhouse arch. A downward air flow is also present in front of the conventional rotating wheel; this causes a high pressure region or ball of air at the wheel-to-road contact point. A strong C-shaped vortex is originated by the interaction of downward flow and the separation of a lateral flow of a boundary layer at the wheel from this high pressure area. An additional upward flow interacts with a boundary layer separation of the wheel. Among others, vortices are created at the rear part of the wheel between the C-shaped vortex and the road but are of less intensity than the C-shaped vortex. It is noteworthy that increases in conventional wheelhouse depth increase the total drag and total downforce, while conventional rotating wheels generate lift and considerable drag. Therefore, it is believed that traditional wheels cause about eight percent of the total vehicle drag. This is especially problemmatic as greater vehicular fuel efficiency and energy range are desired.

Various concepts have been considered for covering the wheelhouse opening. For example, reference should be made to the following U.S. Pat. No. 1,989,368 entitled “Motor Vehicle” which issued to Knapp on Apr. 26, 1933; U.S. Pat. No. 2,010,359 entitled “Automobile” which issued to Davis on Aug. 6, 1935; and U.S. Pat. No. 2,349,421 entitled “Front Fender Shield” which issued to Green on May 23, 1944. These patents are incorporated by reference herein. These traditional devices, however, are very complicated, undesirably take up space, and add significant weight through additional rods, turnbuckles and bars which defeat fuel savings due to aerodynamic improvements; some of these attempt to mechanically move a center of an apron or skirt which is geometrically difficult especially due to wind resistance at high speeds. Moreover, traditional devices still do not reduce much of the circumferential aerodynamic turbulence caused by the wheel rotation.

In accordance with the present invention, an automotive vehicle wheel apparatus includes a turnable cover or door for a front wheelhouse opening in a fender. In another aspect, a sheath or liner is provided close to at least half of a circumference of a wheel. A further aspect blocks and/or removes circumferential air moving with a wheel. Yet another aspect connects an actuator adjacent a front and/or rear edge of a wheel cover so as to turn the cover with the wheel. In still another aspect, an electronic controller causes turning of a cover with a wheel. A method of operating an automotive vehicle, including reducing aerodynamic turbulence, is also provided.

The present apparatus is advantageous over traditional approaches. For example, the present apparatus reduces circumferential wheel air turbulence. Additionally, the present apparatus reduces wheel hub and wheelhouse opening air turbulence. The present apparatus also advantageously provides a much simpler, more cost effective, smaller and lighter weight mechanism to turn a wheel covering door. These aerodynamic and weight saving benefits are ideally suited for electrically driven vehicles in order to improve their operating range or distance for a given amount of stored energy. Additional features and advantages of the present apparatus can be ascertained from the following description and appended claims.

### BRIEF DESCRIPTION OF THE DRAWINGS

FIG. 1 is a side elevational view showing the present apparatus in an automotive vehicle;

FIG. 2 is a cross-sectional view, taking along line 2-2 of FIG. 1, showing the present apparatus;

FIG. 3 is a diagrammatical side view showing a wheel sheath employed in the present apparatus;

FIG. 4 is a diagrammatical side view showing a first embodiment of the present apparatus;

FIG. 5 is a diagrammatical top view showing the first embodiment of the present apparatus;

FIG. 6 is an enlarged cross-sectional view, taking within circle 6 of FIG. 3, showing the wheel liner of the present apparatus;

FIG. 7 is a diagrammatical rear view showing a second embodiment of the present apparatus;

FIG. 8 is a diagrammatical top view showing the second embodiment of the present apparatus;

FIG. 9 is a diagrammatical top view showing a third embodiment of the present apparatus;

FIG. 10 is a diagrammatical side view showing the third embodiment of the present apparatus;

FIG. 11 is a diagrammatical rear view showing the third embodiment of the present apparatus;

FIG. 12 is a diagrammatical top view showing a fourth embodiment of the present apparatus in a first position;

FIG. 13 is a diagrammatical top view showing the fourth embodiment of the present apparatus in a different position; and

FIG. 14 is a cross-sectional view, taken along line 14-14 of FIG. 1, showing an optional lighting system employed in any of the preceding embodiments of the present apparatus.

### DETAILED DESCRIPTION

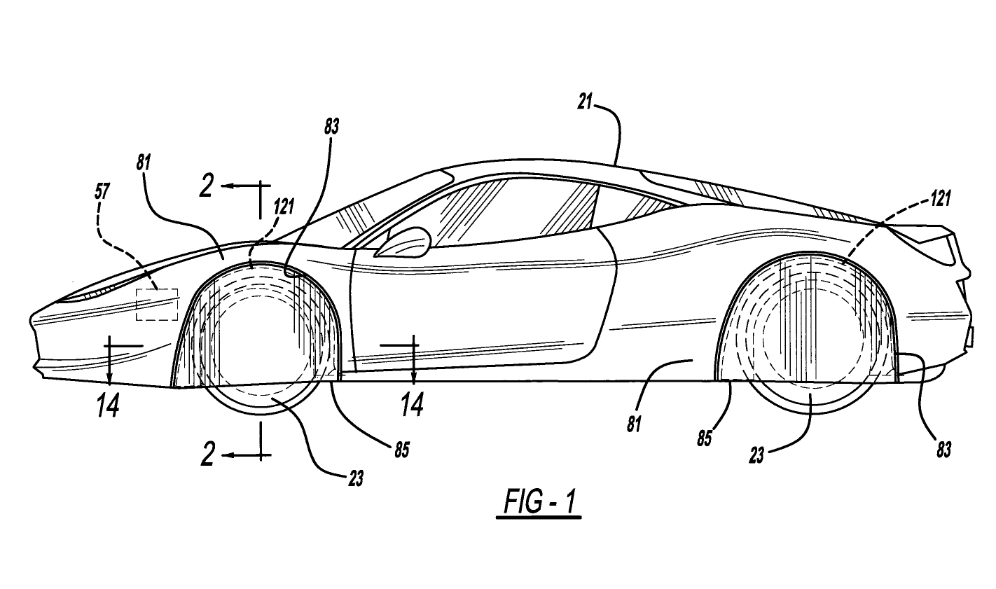

Referring to FIGS. 1-5, an automotive vehicle 21 having multiple passenger seats includes three or four wheels 23 each rotatable about a central hub 27 against a road surface 29. Each wheel includes a rigid metal rim 31 about which is mounted an inflated rubber tire 33. Each wheel is either powered or passive, while each wheel may also be steered or unsteerable, depending upon the vehicular configuration desired. In the specific vehicular configuration shown, the front two wheels are steerable and powered, and the rear two wheels are unsteerable and passive. A lower control arm 41 is coupled to wheel 23 by way of a knuckle 43. Furthermore, a tie rod 45 is coupled to an upright 55 and is either mechanically moved by turning of a steering column or through a motorized actuator, in response to steering wheel rotation by the vehicle driver. A suspension 25 is preferably a MacPherson strut 49 but may alternately employ a torsion bar, leaf spring or other mechanism to allow vertical operating motion of the wheel relative to the vehicular body. A mounting bracket 53 is secured to strut 49 for holding upright 55 coupled to wheel 23.

Automotive vehicle 21 is preferably electrically powered for its traction-driving power to wheels 23. For example, an electric traction motor 57 is provided, although it is also envisioned that a hybrid electric/internal combustion engine, fuel cell or other such primarily electrically driven motor can be employed. Such an electrically driven vehicle places a premium on employing light weight components and a low aerodynamic coefficient of friction in order to obtain an acceptable operating range, such as at least 100 miles of distance for a single battery charge operating at at least 50 miles per hour. It is expected that the present apparatus will assist in achieving these performance characteristics.

The vehicular body includes a fender 81 mounted to a wheelhouse 51, which defines a wheelhouse opening 83 therein. A rigid wheel cover or door 85 is located within and has a peripheral edge that mirrors each wheelhouse opening 83. An inwardly turned lateral wall or lip may be optionally located at the periphery of cover 85. A small and generally uniform gap is longitudinally (fore-and-aft) defined between the peripheral edge of cover 85 and an internal edge of wheelhouse opening 83. Moreover, cover 85 is laterally (cross-car) spaced from and hides a majority of wheel 23 from outside the vehicle when in a nominal, straight forward driving condition. Cover 85 is preferably made from an injection or compression molded polymeric material such as TPO or RIM, but may alternately be made from a layered composite material, a long strand and resinated fiber material such as fiberglass sheets, resinated fabric, or less preferably a stamped metallic sheet such as aluminum. Cover 85 is thereafter painted to match the exterior of the automobile.

Wheel cover 85 is coupled to an inside surface of either wheelhouse 51 or fender 81 by way of a central swivel joint 91 consisting of a ball and socket. For example, a ball is mounted on a stem upstanding from a bracket 93 fastened to or integrally molded to a backside of cover 85. This allows joint rotation or turning of cover 85 from a nominal straight forward position to left and right turned positions 85A and 85B, respectively, as shown in FIG. 5, about a vertical pivot axis. Moreover, swivel joint 91 allows a bottom edge 95 of wheel cover 85 to be outwardly pivoted relative to the vehicle body for removal and servicing of wheel 23, such as for a flat tire or due to tire tread wear. A manually actuable latch with a toggled lever arm trapping a headed pin, screw attachment or other such serviceable release mechanism is used to secure either each flange 97 to wheel cover 85 or stem 105 to the vehicular body. When such latch mechanisms are released, wheel cover 85 can be outwardly pivoted about swivel joint 91.

An offset stepped flange 97 extends from the backside surface of wheel cover 85 adjacent a front edge 99 of the wheel cover and an offset stepped flange 101 is similarly mounted to the backside of cover 85 adjacent a rear edge 103 thereof. The longitudinal sections of flanges 97 and 101 are overlapping behind each respective fender. Each flange has a hole therein through which a stationary stem 105 extends. The stem is affixed to a backside of either the wheelhouse or fender and projects in a generally lateral direction terminating in a large head 107. A compression spring 109 is mounted between head 107 and flange 97 while a second compression spring 111 is mounted between the fender or wheelhouse and flange 97. These compression springs sandwich and center flange 97 therebetween thereby biasing cover 85 to the nominally oriented position. A similar arrangement is provided for flange 101. Alternately, however, leaf springs, extension springs, elastomeric pads or other such members can be used to bias the offset flanges 97 and 101, although certain benefits may not be achieved.

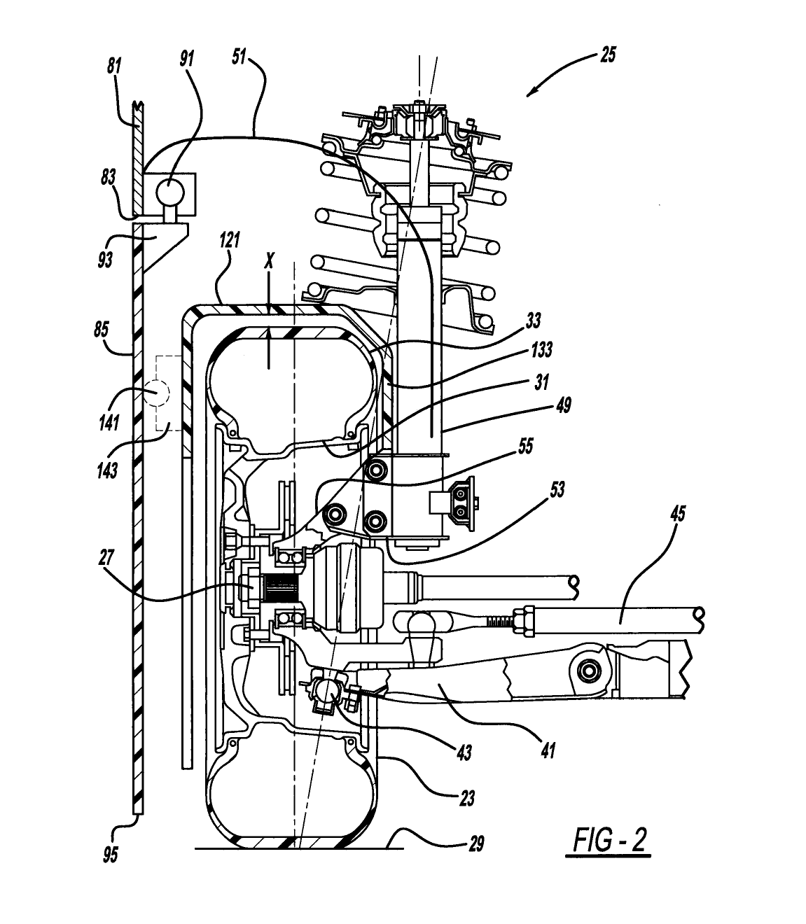

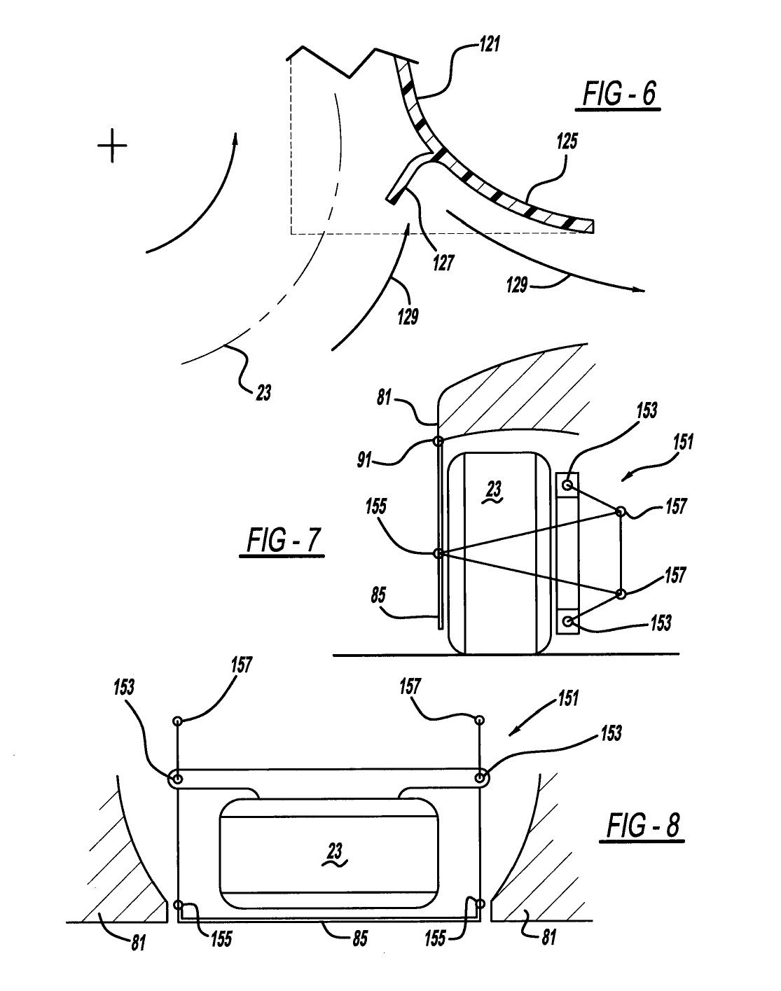

Referring now to FIGS. 2, 3 and 6, a sheath or liner 121 is positioned above and around at least a majority of an outside diameter of wheel 23. For at least the upper half from the wheel, a uniform radial distance x between an inside surface of sheath 121 and an outside diameter of the tire is two inches or less. The distance x is more preferably ½ to ¾ inch. Additionally, a front lower edge 123 of sheath 121 is spaced from a flat road surface 29 by a distance y of two inches or less, and more preferably within one inch. Sheath 121 is preferably injection or compression molded from a somewhat flexible polymeric material, such as polypropylene, so that front lower edge 123 can elastically bend and return to its normal shape if it impacts against a hole in the road, a curb or other obstruction.

A rear segment of sheath 121 includes a longitudinally elongated duck bill shape 125. An inwardly extending wall 127, integrally formed inside sheath 121, is forwardly and downwardly directed toward the wheel from its proximal end joining sheath 121. A distal end of wall 127 is within ¾ inch from the outside diameter of the tire. Wall 127 acts as an aerodynamic scoop to remove and peel off the circumferential boundary layer air being dragged around by rotation of wheel 23. The duck bill shape 125 further channels the removed air 129 away from the wheel and wheelhouse area.

The close dimension of front lower edge 123 of sheath 121 serves to block air flow 131 otherwise hitting wheel 23 during high speed vehicular operation. This also deters the high pressure air vortex from forming at the front of the tire thereby avoiding much of the drag at the wheel-to-road contact point. Furthermore, the close radial distance between sheath 121 and the outside diameter of wheel 23 deters circulation losses of the tire in the wheelhouse otherwise due to moving boundary layer air caused by the tire tread and the turbulent air flow drag otherwise created by traditional interactions of this air with the wheelhouse.

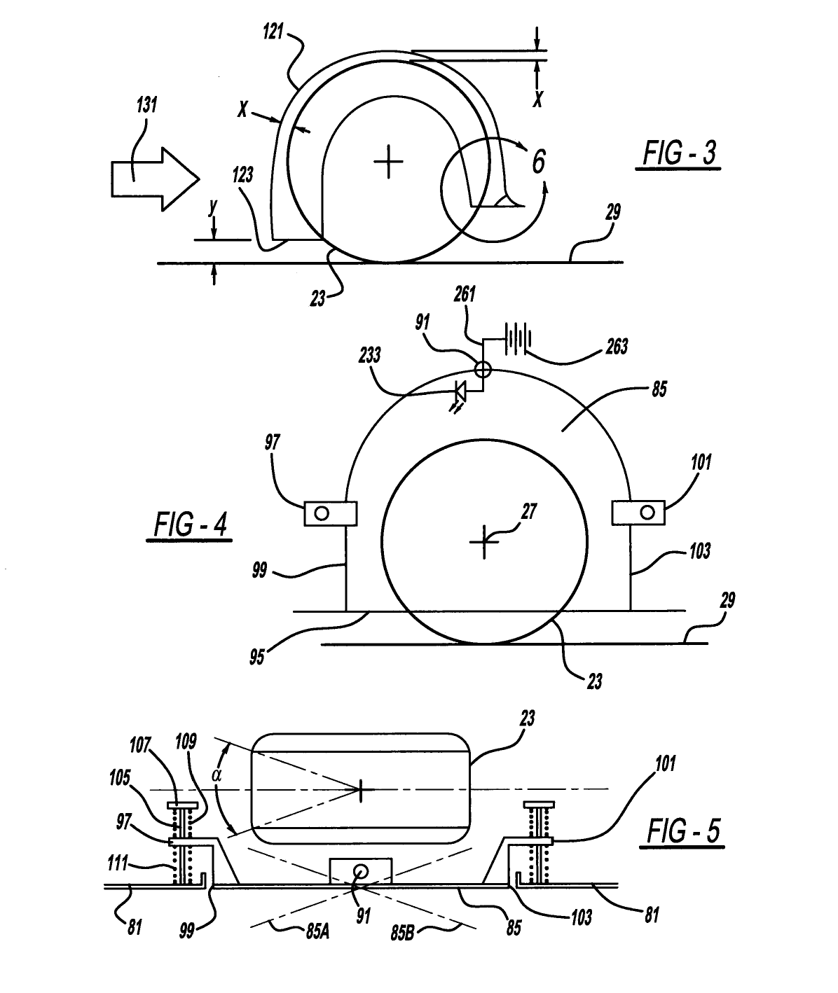

Sheath 121 has a somewhat inverted U-shape when viewed in a side elevation (like FIG. 3) and also when viewed in cross-section (like FIG. 2). An inside wall 133 of sheath 121 is bolted onto bracket 53 of suspension 25. Thus, sheath 121 steerably turns side-to-side with wheel 23 and also vertically moves up and down with wheel 23 due to irregularities in the round surface 29.

During operation at high speeds, such as above 50 miles per hour, there is enough lateral clearance between an outside surface of sheath 121 and an inside surface of wheel cover 85 so as to allow approximately 5-10 degrees of steered turning movement a without requiring movement of wheel cover 85 from its nominal position. This enhances high-speed aerodynamics by providing a continuous and uninterrupted air flow pattern along the adjacent outside vehicle surface. At slower speeds and for more abrupt steering at faster speeds, steered rotation of the wheel causes a front side corner or rear side corner of sheath 121 to contact against and push open the corresponding portion of wheel cover 85. Springs 105 and 111 will cause cover 85 to return to its nominal position when the wheel and sheath are straightened back out and the contact is removed from the cover. Optionally, a rotatable ball 141 and race 143, such as a ball bearing device, are attached to either sheath 121 or cover 85 to provide the contact points therebetween.

FIGS. 7 and 8 show a different embodiment used to actuate wheel door 85. The sheath of the prior embodiment can be also employed with this construction, however, such is not required. A swivel joint 91 like the prior embodiment is used to couple wheel cover 85 to a vehicular body such as the fender or wheelhouse.

Joints 157 are attached to rigid links. The present embodiment employs a Robert's straight line motion, four-bar linkage 151. The cross-car lateral distance between joints 153, attached to an upright or arm of the suspension to the joint 155 of wheel cover 85, is a fixed distance for a given range of motion which allows the wheel to move vertically independent of the wheel cover. The wheel cover, however, will follow wheel 23 when its steering angle is changed. This system avoids the need for a sheath to push against the wheel cover and also avoids the need for a cover biasing mechanism.

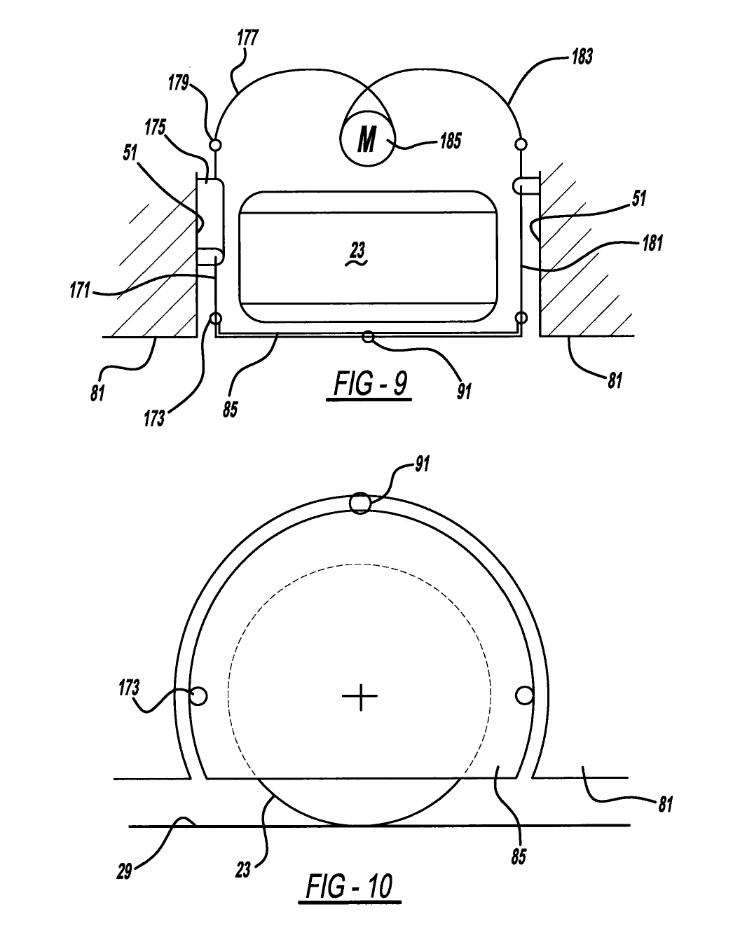

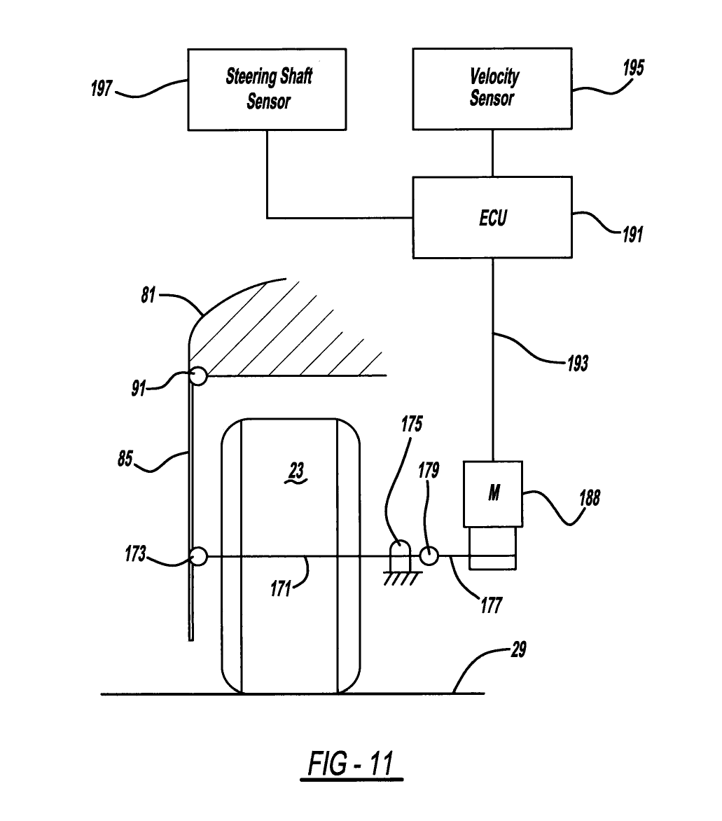

Another embodiment of the present apparatus is illustrated in FIGS. 9-11. Wheel cover 85 and central swivel joint 91 are generally the same as with the prior embodiments. A different driving mechanism is provided, however, with the present exemplary embodiment. This driving mechanism includes a generally rigid rod 171 coupled by way of a hinged joint 173 adjacent a front inside edge of cover 85. Joint 173 can be a vertical pin clipped into a hollow collar by way of example. A pair of yoke-like brackets or an elongated tubular bracket 175 is secured to an inside of the automotive vehicle body, such as at wheel house 51, and has an internal aperture through which rod 171 extends. The front bracket 175 deters undesired lateral fore and aft movement of the wheel cover. Rod 171 is elongated in a primarily lateral and horizontal direction. Elongated and flexible cable 177 extends between a cable drum affixed to the vehicular body and a joint 179 attached to a proximal end of rod 171. A pin and eyelet or other connection may be used at joint 179. Cable 177 is of a push-pull type like that used for a motorcycle throttle cable. A similar rod 181 and cable 183 are connected to cover 85 adjacent a rear edge portion thereof. Connecting the driving mechanism adjacent the front and rear edges of wheel cover 85 provides superior geometric leveraging about the central fulcrum-like joint 91 as compared to some conventional aprons or skirts. Moreover, such greater longitudinal geometric leveraging adjacent the front and rear edges will better assist at overcoming the aerodynamic pressures pulling on wheel cover 85 when it is turned to an open position.

An electric motor actuator 185 pushes and pulls cables 177 and 183 into and out of the cable drum for turning door 85. Furthermore, an electronic control unit or body computer 191 is electrically connected to motor 185 by an electrical circuit 193. Programmed computer instructions within non-transient memory, such as RAM, ROM or the like, of electronic control unit 191 operably receive a velocity signal and a steering angle signal from an optional electrical velocity sensor 195 and a steering shaft sensor 197, respectively, based on operating conditions of the vehicle. The electronic control unit then automatically compares the real time received velocity and steering angle signals and compares them to previously stored threshold signals in the memory. Next, the electronic control unit calculates and determines if electric motor 185 should be energized or de-energized to automatically turn wheel cover 85 to allow desired clearance for steering of wheel 23 optionally depending upon the vehicular speed.

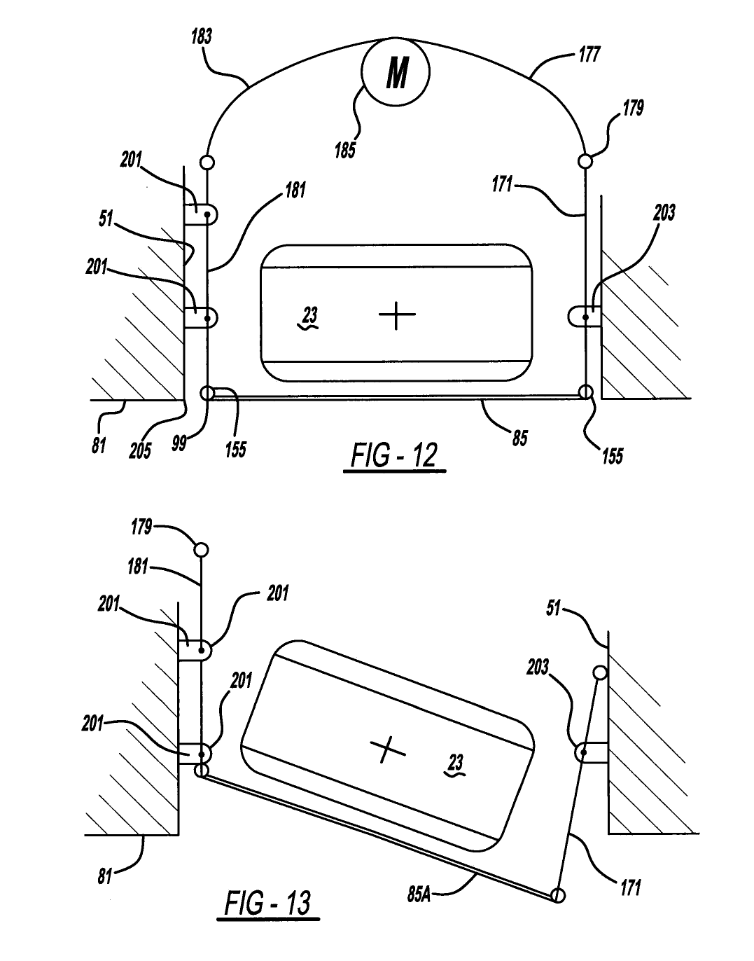

Referring now to FIGS. 12 and 13, another embodiment of the present apparatus includes a wheel cover 85, rods 171 and 181, and cables 177 and 183, like the prior embodiment. The difference, however, is that a pair of yoke-like brackets 201 are mounted to wheelhouse 51 at a front wall thereof while a single yoke-like bracket 203 is mounted to a rear wall of the wheelhouse. The double yoke brackets 201 contain apertures through which elongated rod 181 moves. This provides a double-ground for rod 181 in order to maintain a constant gap between front edge 99 of wheel cover 85 and an adjacent edge 205 of fender 81 during cover movement between a nominal straight forward position of FIG. 12 and the left turn position of FIG. 13, which improves aerodynamics and aesthetic appearance from outside the vehicle. A central swival joint may not be needed or desireable with this construction.

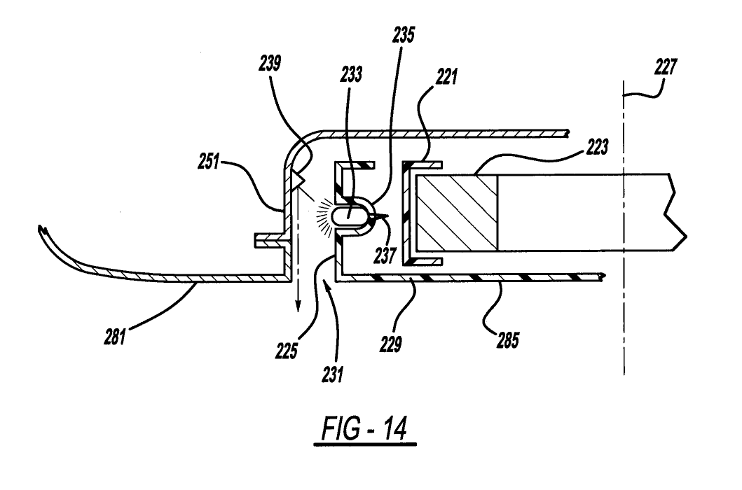

FIGS. 4 and 14 illustrate an optional illumination arrangement for the present apparatus. The wheel cover 285 externally covers at least half of both a circumference and an outside surface of wheel 223 which rotates about a lateral hub axis 227. Cover 285 of this embodiment additionally has a laterally elongated wall 225, which is generally perpendicular to outer wall 229. A generally uniform gap 231 is located between wall 225 and an inside surface of fender 281 and wheelhouse 251.

A sheath or liner 221 closely covers at least an upper half of wheel 223 as in the first embodiment. An illumination source 233, preferably an elongated string containing multiple connected light emitting diodes, is secured within a trough 235 of wall 225 of the wheel cover. A rivet, Christmas tree-type push pin or other fastener 237, is used to retain the LED string within trough 235. The LED string is at least twenty times longer than wide in any cross-sectional direction. Furthermore, an elongated reflector 239 is affixed inside wheelhouse 251 so as to outwardly reflect light emanating from illumination source 233. Reflector 239 is either adhesive backed reflective tape or a polymeric rigid device. This lighting arrangement provides an aesthetically attractive illuminated gap along the entire periphery between wheel cover 285 and fender 281. This can also serve as a side marker lamp to enhance traffic safety.

An electrical wire 261 connects a stored power source, such as a battery 263, to illumination source 233. In order to do this, wire 261 is fed from the battery compartment, within the vehicular body, through swivel joint 91 which has a hollow center and to a backside of wheel cover 285. As an alternative, such a wire routing configuration can be used to supply electricity to a light emitting diode or an incandescent light bulb mounted to the exterior, generally vertically planar surface of wheel cover 285 to either illuminate a brand name on an aesthetically pleasing ornamental trim piece or as a functional side marker lamp. It is also envisioned that a reflector may not be necessary.

While various constructions of the present wheel apparatus have been disclosed herein, other variations can be made. For example, solenoid or fluid powered actuators can be employed to move the wheel cover instead of an electric motor, although various advantages of the present apparatus may not be achieved. Additionally, the wheel sheath may be used without an external wheel cover or vice-versa, although certain benefits will not be realized. The wheel cover and/or sheath can also be used for the rear wheels. Moreover, the disclosed connecting rods and/or cables can be replaced by cables, links, belts or other devices although certain advantages will not be obtained.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the present disclosure, and all such modifications are intended to be included within the scope of the present disclosure.

The invention claimed is:

1. An automotive vehicle apparatus comprising:
a rotatable wheel including a tire having an outside diameter;
a sheath including an inside surface covering at least half of the outside diameter of the wheel with a substantially uniform radial distance of two inches or less between the outside diameter and a majority of the inside surface; and
a stationary wheelhouse located above the sheath which is above the wheel;
the sheath turning with the wheel when the wheel is steered and the sheath being spaced away from a road surface.

2. The apparatus of claim 1, further comprising an exterior cover filling a majority of a wheelhouse opening in an exterior fender, the cover turning when the wheel turns in at least one steering condition, and the cover hiding at least a majority of the wheel and sheath from outside the vehicle when the wheel is rotating and steered in a straight forward direction.

3. The apparatus of claim 2, wherein a majority of the sheath and cover are of a material selected from: a polymer, a composite, long strand resinated fibers, a resinated fabric, or combinations thereof.

4. The apparatus of claim 2, wherein the sheath directly contacts against an inside of the cover to turn the cover.

5. The apparatus of claim 2, further comprising a roller located between the sheath and cover, the roller contacting against at least one of the cover and the sheath to cause the cover to turn with the wheel in at least one steering condition.

6. The apparatus of claim 1, wherein a front lower edge of the sheath forward of the wheel is located within two inches of a flat road surface.

7. The apparatus of claim 6, wherein the front lower edge of the sheath is located within one inch of the flat road surface, and the front lower edge of the sheath is a flexible polymeric material.

8. The apparatus of claim 1, wherein a rear lower edge of the sheath behind the wheel has a duck bill shape further away from the tire than the uniform radial covering distance therebetween.

9. The apparatus of claim 1, wherein the sheath includes an inwardly angled wall removing air rotating with the outside diameter of the tire when the wheel rotates.

10. The apparatus of claim 1, further comprising a suspension bracket located inboard of the wheel, the sheath being attached to the bracket which is steerable and vertically moveable with the wheel, the sheath being polymeric, and the sheath having a substantially inverted U-shape when viewed from a side of the vehicle.

11. An automotive vehicle apparatus comprising:
a rotatable wheel including a tire having an outside diameter;
a sheath including an inside surface covering at least an upper portion of the outside diameter of the tire; and
a wall inwardly angling from the sheath toward the tire to remove air rotating with the outside diameter of the tire when the tire rotates;
the sheath turning with the wheel when the wheel is steered.

12. The apparatus of claim 11, further comprising a stationary wheelhouse within which the sheath is located and the wheel rotates in at least one operating condition, the wall inwardly angling behind the wheel, and the wall being integrally part of the sheath.

13. The apparatus of claim 11, wherein a rear edge of the sheath behind the wheel has a duck bill shape further away from the tire than a nominal radial distance therebetween.

14. The apparatus of claim 11, further comprising a suspension bracket located inboard of the wheel, the sheath being attached to the bracket which is steerable and vertically moveable with the wheel, the sheath being polymeric, and the sheath having a substantially inverted U-shape when viewed from a side of the vehicle.

15. The apparatus of claim 11, further comprising an exterior cover filling a majority of a wheelhouse opening in an exterior fender, the cover turning when the wheel turns in at least one steering condition, and the cover hiding at least a majority of the wheel and sheath from outside the vehicle when the wheel is rotating and steered in a straight forward direction.

16. The apparatus of claim 11, wherein a front lower edge of the sheath forward of the wheel is located within two inches of a flat road surface.

17. An automotive vehicle apparatus comprising:
a rotatable and turnable wheel;
a stationary wheelhouse above the wheel;
a fender including a wheelhouse opening;
a cover located within at least a majority of the wheelhouse opening and outboard of the wheel, the cover being tumable with the wheel but independent of the wheelhouse in at least one steering condition;
a connector coupled to the cover adjacent a front edge thereof; and
an actuator operably moving the connector which assists in turning the cover with the wheel in the at least one steering condition.

18. The apparatus of claim 17, wherein the connector includes a cable.

19. The apparatus of claim 17, wherein the connector is a rigid linkage.

20. The apparatus of claim 17, wherein the connector includes an elongated rod extending in a substantially cross-car direction which is coupled to a stationary segment of the vehicle by at least one yoke.

21. The apparatus of claim 17, wherein the connector is part of a Robert's straight line motion, four bar linkage.

22. The apparatus of claim 17, wherein the actuator includes an electromagnet.

23. The apparatus of claim 17, wherein the actuator is part of a steering mechanism.

24. The apparatus of claim 17, further comprising a second connector coupled adjacent a rear edge of the cover to assist in turning the door with the wheel, and at least one spring biasing the door into a position substantially flush with the adjacent portion of the fender.

25. An automotive vehicle apparatus comprising:
an electrically driven automotive vehicle having a distance range of at least 100 miles per battery charge if operating at 50 miles per hour or faster;
a rotatable and steerable wheel;
a stationary wheelhouse above the wheel;
a fender including a wheelhouse opening;
a door located within at least a majority of the wheelhouse opening outboard of the wheel, the door being steerable with the wheel but independent of the wheelhouse in at least one steering condition;
a front flange extending in an offset manner adjacent a front edge of the door;
a rear flange extending in an offset manner adjacent a rear edge of the door;
the flanges being substantially hidden from outside the vehicle by the door and the fender, at least an end of the flanges overlapping behind the fender;
the door being rigid and made from at least one of the following materials:
a polymer, a composite, resinated long strand fibers, or resinated fabric; and
at least one biasing member biasing at least one of the flanges relative to the wheelhouse.

26. The apparatus of claim 25, further comprising a connector coupled to the door, the connector being at least one of: a cable, an elongated rod, or a rigid linkage.

27. The apparatus of claim 25, further comprising a swivel joint coupling a longitudinal center of the door to at least one of the fender or the wheelhouse.

28. The apparatus of claim 25, wherein the biasing member is one of multiple springs sandwiching the corresponding flange therebetween.

29. The apparatus of claim 25, further comprising an illumination source attached to and moveable with the door.

30. An automotive vehicle apparatus comprising:
a rotatable and steerable wheel;
a vehicular body including a wheelhouse;
a cover coupled to the vehicular body and being located outboard of the wheel, the cover being turnable about a substantially vertical axis but independent of the wheelhouse in at least one steering condition;
an electronic controller operably receiving a steering signal and a velocity signal; and
an actuator connected to the electronic controller, the electronic controller operably causing the actuator to turn the cover in at least one steering and velocity condition.

31. The apparatus of claim 30, wherein the actuator includes an electromagnet.

32. The apparatus of claim 30, further comprising a connector coupling the actuator to the cover, the connector including at least one of: a cable, an elongated rod, or a rigid linkage.

33. The apparatus of claim 30, further comprising a swivel joint coupling a longitudinal center of the cover to at least one of a fender or the wheelhouse.

34. The apparatus of claim 30, further comprising a suspension bracket located inboard of the wheel, a polymeric sheath being attached to the bracket and located inside the wheelhouse, and a majority of an inner surface of the sheath being within two radial inches from an outside diameter of the wheel.

35. The apparatus of claim 30, wherein the actuator is an electric motor which operably pulls an elongated cable coupled to a front, inside section of the cover so as to turn the cover about a longitudinally central joint.

36. An automotive vehicle apparatus comprising:
a rotatable and steerable wheel;
a vehicular body including a wheelhouse above the wheel;
a cover attached to the vehicular body and being located outboard of the wheel, the cover being turnable about a substantially vertical axis but independent of the wheelhouse in at least one steering condition; and
an illumination source attached to and moveable with the cover.

37. The apparatus of claim 36, wherein the illumination source is elongated to have a length at least twenty times as long as wide, and the illumination source includes at least one light emitting diode.

38. The apparatus of claim 36, wherein the illumination source is located between the cover and the wheelhouse when the wheel is in a straight forward position, and the illumination source being located on a section of the cover in front of the wheel, on a section of the cover above the wheel and on a section of the cover behind the wheel.

39. The apparatus of claim 36, further comprising a hollow joint moveably coupling the cover to the vehicular body, and an electricity carrying wire extending through the joint and being connected to the illumination source.

40. A method of operating an automotive vehicle, the method comprising:
(a) reducing aerodynamic drag due to wheel rotation by rotating the wheel within a sheath positioned within two inches of a circumference of at least half of the wheel;
(b) reducing aerodynamic drag by rotating the wheel between an exterior side cover and a wheelhouse;
(c) using an electronic controller to turn the cover with the wheel and independent of the wheelhouse in at least one operating condition.

41. The method of claim 40, further comprising steering the sheath with the wheel and vertically moving the sheath with the wheel.

42. The method of claim 40, further comprising removing air rotating with the circumference of the wheel by an internal wall of the sheath.

43. The method of claim 40, further comprising supplying electricity to a light mounted on and moveable with the cover.
